(19) United States
(12) Patent Application Publication
(10) Pub. No.: US 2008/0176690 A1
(43) Pub. Date: Jul. 24, 2008

(54) Anti-rewet transfer belt

(76) Inventor: Leonard R. Lefkowitz, Latham, NY (US)

Correspondence Address: YOUNG & THOMPSON, 209 Madison Street, Suite 500, ALEXANDRIA, VA, 22314, US

(21) Appl. No.: 11/654,510

(22) Filed: Jan. 18, 2007

(51) Int. Cl. F16G 1/26

(52) U.S. Cl. 474/153

(57) ABSTRACT

An endless belt for a press section forces a controlled amount of air into a sheet to relieve a vacuum in the sheet during dewatering of the sheet. The first surface of the belt is impermeable to water and permeable to air and the second surface of the belt is impermeable to water and air. Between the first and second surfaces is a body that is resiliently compressible and that has a plurality of air pockets that communicate vertically with the first surface. The air pockets are arranged to essentially stop passage of air through the belt in machine and cross machine directions. Air is compressed in the air pockets as the belt enters the nip, and the compressed air leaves the air pockets to relieve the vacuum in the sheet as the belt passes beyond mid-nip, preventing water from reentering the sheet.

### BACKGROUND OF THE INVENTION

The present invention is directed to an endless belt for a press section, and is particularly useful for removing water from a paper web or sheet in a press section of a papermaking machine.

The present application incorporates by reference all that is disclosed in U.S. Pat. No. 5,700,536 issued to the present inventor on Dec. 23, 1997.

The extent to which water can be removed from a paper sheet by mechanical pressing has been limited by sheet “rewetting” after the mid-nip. In a typical papermaking operation, water is removed from a wet paper sheet by pressing the sheet between two press rolls while the sheet is supported and conveyed on a porous press felt through the nip formed by the press rolls. As the mechanical pressure at the nip compresses the sheet and felt, water is expressed from the sheet into the pore spaces of the felt. Under maximum press load during mid-nip passage; that is, at the middle or mid-point of the nip where the distance between the two press rolls is a minimum, a large portion of the water formerly contained within the pore spaces of the sheet is squeezed or expressed from the sheet to the interface between the sheet and the press felt and within the void spaces of the press felt. Subsequently, during post mid-nip passage; that is, immediately after passing the mid-point of the nip, the rolls begin to diverge and a low pressure (denoted a vacuum in the art) is created. As a result of this vacuum, and because the capillaries within the paper sheet are finer than those within the press felt, the widening nip is filled with air from the felt side of the nip. As a result, the vacuum is present for a longer period of time in the sheet than in the felt, thereby drawing the water that was just expressed from the sheet back into the sheet and causing sheet rewetting after the mid-nip. The rewetting decreases sheet consistency as the sheet leaves the nip.

The present invention is directed to a solution of the sheet rewetting problem.

### SUMMARY OF THE INVENTION

A preferred embodiment of the present invention is an endless belt, denoted herein as an anti-rewet transfer belt, for a press section that forces a controlled amount of air into a sheet to relieve a vacuum in the sheet during dewatering of the sheet. The belt includes a first surface that is impermeable to water and permeable to air and a second surface that is impermeable to water and air. Between the first and second surfaces is a body that is resiliently compressible and that has a plurality of air pockets that communicate vertically with the first surface. The air pockets are arranged to essentially stop passage of air through the belt in the machine and cross machine directions. Air is compressed in the air pockets as the belt enters the nip, and the compressed air leaves the air pockets to relieve the vacuum in the sheet as the belt passes beyond mid-nip, preventing water from reentering the sheet.

An object of the present invention is to provide a novel anti-rewet transfer belt that increases the amount of water removed from a sheet during a press dewatering phase of a sheet making process.

A further object of the present invention is to provide a novel endless belt for a press section, the belt extending in the machine and cross machine directions and having a vertical thickness, where the belt includes a first sheet contact layer that is substantially impermeable to water and permeable to air, a second layer that is impermeable to water and air and that includes a dimensionally stable substrate, and between the first and second layers, a compressibly resilient body having a plurality of air pockets that are arranged to intake and exhaust air vertically through the first layer and that are arranged to essentially bar movement of air through the body in the machine and cross machine directions.

These and other objects and advantages of the invention will be apparent to those of skill in the art of the present invention after consideration of the following drawings and description of preferred embodiments.

### BRIEF DESCRIPTION OF THE DRAWINGS

FIG. 1 is a pictorial representation of a cross section of part of a press section in which the present invention finds utility.

FIGS. 2a-c are graphs depicting mechanical pressure through the nip, air pressure in the belt of the present invention, and air pressure in the sheet.

FIG. 3 is a pictorial and partial cross sectional representation of a first embodiment of the belt of the present invention.

FIG. 4 is a pictorial and partial cross sectional representation of a second embodiment of the belt of the present invention.

FIG. 5 is a pictorial and partial cross sectional representation of a third embodiment of the belt of the present invention.

### DESCRIPTION OF PREFERRED EMBODIMENTS

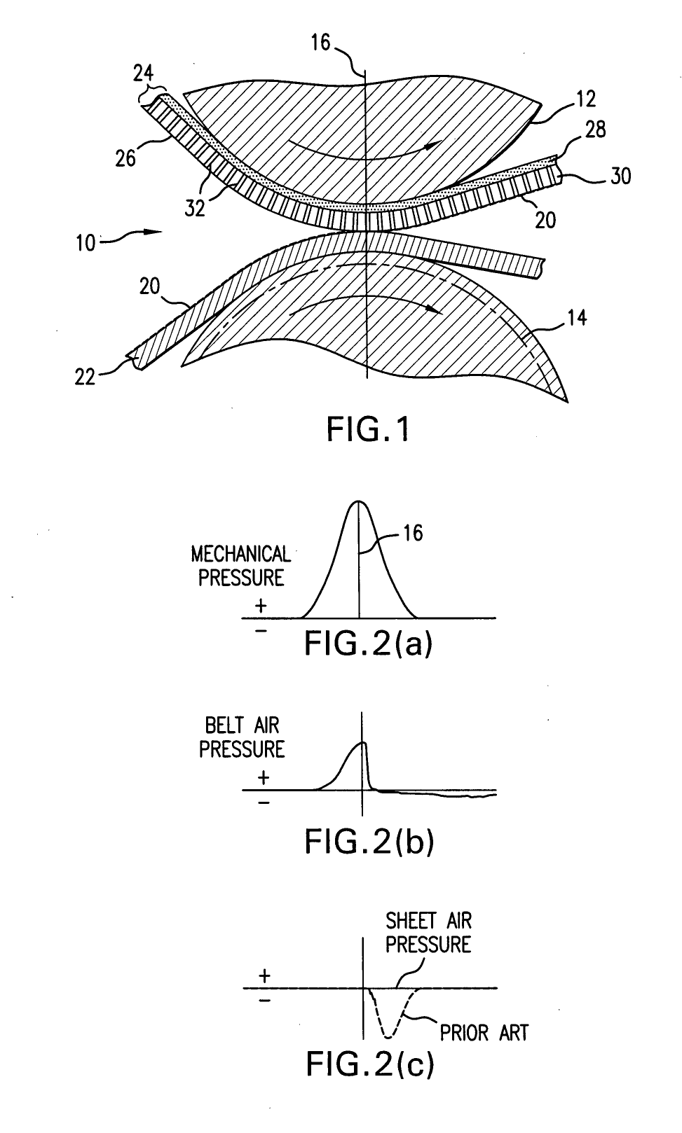

With reference now to FIG. 1, the belt of the present invention finds utility in a press section 10 that includes a top roll 12, which is typically plain, and a bottom roll 14, which is typically grooved, that come together at a nip whose center (denoted the mid-nip) is marked by the line 16. The sheet or web 26 (shown as a dashed line) enters the nip supported on a press felt 22 and leaves the nip on the anti-rewet belt 24 of the present invention. As will be explained in more detail below, the belt 24 extends in the machine and cross machine directions (from left to right and into and out of the drawing) and has a vertical thickness (from top to bottom in the drawing) and includes a barrier layer 26 that is substantially impermeable to water and permeable to air, a belt support layer 28 that is completely impermeable to water and air and that includes a dimensionally stable substrate, and between the barrier and belt support layers, a compressibly resilient body 30 having a plurality of air pockets 32 that are arranged to intake and exhaust air vertically through the barrier layer 26 and that are arranged to essentially bar movement of air through the body 30 in the machine and cross machine directions. Air is compressed in air pockets 32 as belt 24 enters the nip, and the compressed air leaves air pockets 32 and is injected into sheet 20 to relieve the vacuum in sheet 20 as belt 24 and sheet 20 pass beyond mid-nip, thereby preventing water from rewetting sheet 20 or at least reducing an amount of water reentering sheet 20.

The barrier layer 26 being “substantially impermeable” means that water does not enter the barrier layer at the maximum mechanical pressure in the nip and within the very brief time that the barrier layer is in the nip. Air permeable means permeable to air at atmospheric pressure and higher. The reference to vertical movement of air is not intended to limit the movement to 90° to the plane of the belt; some minor diversions away from vertical are permitted, such as within about a quarter of the nip width. Air should pass principally in the vertical direction while seeking an exit path to the surface of the barrier layer. However, air should not be permitted to escape to the edges of the nip or escape through edges of the belt as this would detract from the injection of air into the sheet just beyond mid-nip that offsets the vacuum in the sheet.

FIGS. 2a-c show the pressure changes within belt 24 (+ and − are relative to ambient). FIG. 2a shows mechanical pressure applied to belt 24 in the nip (mid-nip again at line 16) with the peak mechanical pressure occurring at mid-nip. FIG. 2b shows the air pressure within body 30 of belt 24 with the peak air pressure being generated at mid-nip. Immediately after passage beyond mid-nip, air pressure in body 30 is no longer contained within the barrier layer by water in the pressurized saturated sheet pressing against the barrier layer. The belt presses against the sheet that is not saturated with water but, to the contrary, presents a vacuum in the expanding nip, encouraging the flow of pressurized air from the belt void spaces into the sheet to the relieve the slightly negative pressure differential. That is, the expanding nip permits air to escape through the air permeable barrier layer 26 and into sheet 20 on belt 24. FIG. 2c shows the air pressure in sheet 20, wherein the air pressure is essentially ambient following passage through the nip (the air pressure is shown on the horizontal axis). That is, in the present invention the air pressure is represented by a straight line so that belt 24 substantially eliminates the vacuum that occurs in the prior art that draws water back into the sheet. The air pressure in sheet 20 without a belt of the present invention is also shown in FIG. 2c as the dashed line in which a momentary negative pressure pulse causes resaturation of the sheet prior to the sheet exiting the nip. As best understood, the maximum low pressure (vacuum) occurs almost immediately after passage through the mid-nip, and it is this vacuum in sheet 20 that rewets the sheet. By contrast, the belt of the present invention essentially eliminates the vacuum in sheet 20 to reduce rewetting.

The near elimination of the vacuum is caused by injection of compressed air from air pockets 32 through barrier layer 26 and into sheet 20. The compressed air is compelled in the direction of the sheet by the construction of body 30 that restricts movement of the air in the machine and cross machine directions and permits vertical air movement. Air is compressed in air pockets 32 during passage through the nip and held there by the mechanical pressure of the nip and the construction of body 30 that prevent air from escaping in the machine and cross machine directions. Water is prevented from entering the air pockets by water-impermeable barrier layer 26 and water-impermeable belt support layer 28. Within a few fractions of a milliseconds, just as the belt and sheet start to pass beyond mid-nip and before mechanical relaxation of body 30, and as the vacuum attempts to form in the sheet, air is released vertically from air pockets 32 to relieve the vacuum (the horizontal sheet air pressure line in FIG. 2c depicts this). After passage through the nip, body 30 decompresses and refills with air.

That is, due to the compressed air in the belt, the restriction of air motion in the machine and cross machine directions, and the vacuum attempting to form in the sheet, air from the air pockets escapes from the belt and moves into the sheet before the sheet can be rewet with water.

A further feature of the present invention that provides an added and unexpected benefit is that the compressibly resilient structure of the body 30 is the delayed elastic recovery that takes place after passage through the nip. FIG. 2b shows a slight low pressure forming in the body after passage through the nip that is caused by air being drawn back into the voids in the body. This slight low pressure helps hold the sheet on the belt until the next transfer point in the process.

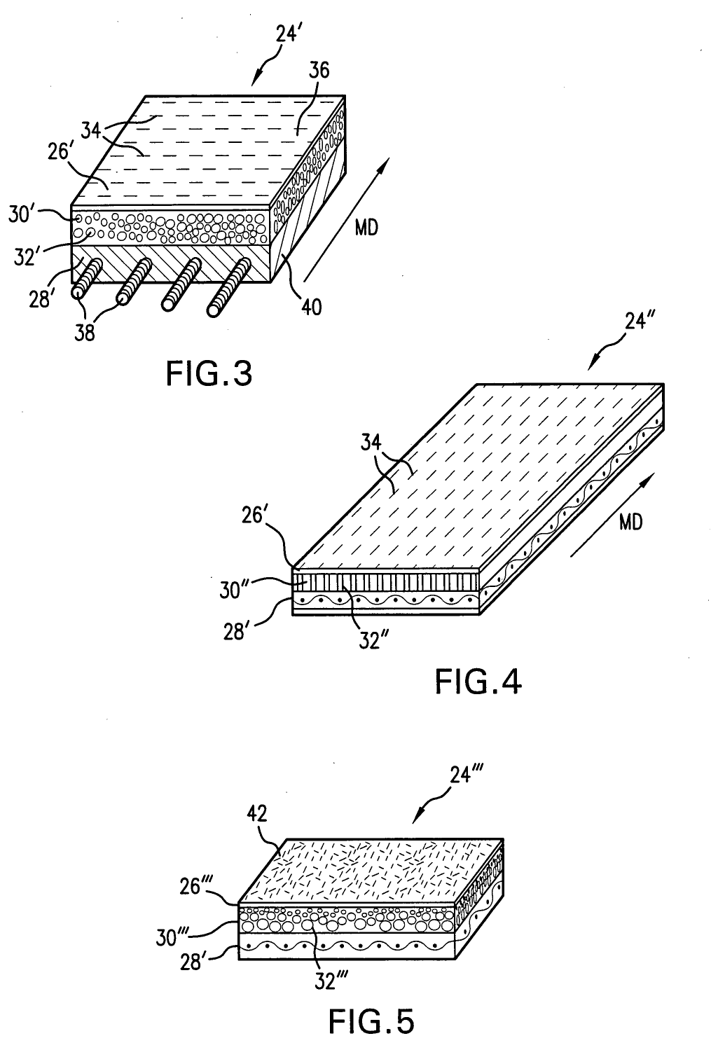

With reference now to FIG. 3, a first embodiment of the present invention is belt 24′ that includes barrier layer 26′ that is adapted to contact sheet 20. Barrier layer 26′ may be perforated polyurethane that is about 0.7 mm thick. The perforations may be plural slits 34 arranged transverse to a machine direction MD (or along the machine direction as shown in FIG. 4), where slits 34 are about 1 mm long with about 1 mm spacing between the slits, where the slits are arranged in rows about 3 mm apart. Slits 34 are permeable to air and substantially impermeable to water. Other perforations, such as small pores, are also suitable. Barrier layer 26′ may also include a coating of a water repellant material 36, such as polytetraflouroethelene, to provide a water repellant sheet-contacting surface. Where the slits are arranged in the cross machine direction (FIG. 3), mechanical tension forces may be varied to adjust the flow resistance through the barrier layer, such as to allow for the effects of wear.

Belt 24′ also includes a compressibly resilient body 30′ having a plurality of air pockets 32′ that are arranged to intake and exhaust air vertically through slits 34 in the barrier layer 26′ and that are arranged essentially bar movement of air through the body 30′ in the machine and cross machine directions. Air pockets 32′ communicate directly with corresponding slits 34 and should be larger than slits 34 to provide an air reservoir of suitable size for injecting air into sheet 20. Desirably, the air pockets provide a total volume larger than a volume of the sheet passing through the nip. Body 30′ includes polyurethane or similar particles forming walls that define vertical flow passageways, much like a sponge except the passageways do not extend in the machine and cross machine directions. Desirably body 30′ has a Shore A scale hardness of at least 70. Barrier layer 26′ and body 30′ may comprise a same material, such as a suitable polymer.

Belt 24′ also includes a belt support layer 28′ that provides dimensional stability to the belt and wear-resistance. Dimensional stability means that the layer 28′ does not effectively change its shape or size under the maximum pressure at mid-nip. Layer 28′ includes a yarn layer 38 embedded in a substantially incompressible polymer 40. Yarn layer 38 may be separate monofilaments extending in the machine direction or a woven fabric (e.g., shown in FIG. 4). The surface of polymer 40 that is adapted to contact top roll 12 provides a solid impermeable surface that is resistant to wear. Layer 28′ with its substantially incompressible polymer 40 reduces dynamic compression severity, thereby reducing belt fatigue and belt aging.

With reference now to FIG. 4, a second embodiment of the present invention is belt 24″ that includes a barrier layer 26′ and a belt support layer 28′ and other features similar to those of FIG. 3. This embodiment includes a compressibly resilient body 30″ having a plurality of air pockets 32″ that are arranged to intake and exhaust air vertically through slits 34 in the barrier layer 26′ and that are arranged to essentially bar movement of air through the body 30″ in the machine and cross machine directions. Air pockets 32″ are vertical through-holes that extend through body 30″ into communication with respective slits 34. Air pockets 32″ have a size sufficient to provide suitable air reservoirs for injection of a sufficient amount of air into sheet 20. For example, body 30″ may be a 1.5 mm thick EPDM rubber sheet (Shore A hardness of about 60) having 1.5 mm diameter through holes (e.g., made by drilling) spaced about 3 mm apart. Alternatively, barrier layer 26′ and body 30″ may comprise a same material, such as a suitable polymer. In a further alternative, body 30″ may be a perforated air reservoir layer of polyether polyurethane about 1 mm thick, with a Shore A scale hardness of about 80, about 30% open area and about 8 perforations per square centimeter. The barrier layer would have corresponding water impermeable and air permeable perforations.

A third embodiment is shown in FIG. 5. This embodiment is a belt 24′″ that includes a belt support layer 28′ and other features similar to those of FIG. 3. This embodiment includes a barrier layer 26′″ and compressibly resilient body 30′″ that are a same material having a plurality of interconnected air pockets 32′″ that are arranged to intake and exhaust air vertically through a surface of barrier layer 26′″ and that are arranged to essentially bar movement of air through body 30′″ in the machine and cross machine directions. Air pockets 32′″ are graduated in size so as to be smaller at surface 42 than in the interior to make surface 42 impermeable to water and permeable to air. As with the previous embodiments, the interior air pockets 32′″ have a size sufficient to provide suitable air reservoirs for injection of a sufficient amount of air into sheet 20 to relieve the vacuum in the expanding nip.

Further embodiments include combinations of these three embodiments. For example, the air pockets 32″ in the embodiment of FIG. 4 that are vertical through holes, may extend to the surface of barrier layer 26′ with the holes being larger in the interior and narrowing at the surface (much as in the embodiment of FIG. 5) to be impermeable to water and permeable to air. The through holes may be shaped as a venturi to accelerate the jet of air into the sheet, although care must be taken to avoid damaging the sheet.

In a further embodiment, the air pockets in the belt may be charged with a vapor other than air that introduces a chemical agent into the sheet as the air pockets eject their contents immediately beyond mid-nip. The vaporized chemical agent may be one known in the art for providing a special coating or other particular property to the sheet. A pressurized slot, Uhle box, or other suitable device may be used to introduce the vapor into the air pockets in the belt prior to entering the nip.

In yet a further embodiment, the belt 24 may be pressurized above atmospheric pressure before entering the nip so that the air pockets are pre-pressurized. Again, the pressurized slot, Uhle box, or other suitable technology for pressurizing the belt may be used.

Further, pressurized air may be metered into the sheet before mid-nip to create a mix of aerated sheet fibers and water prior to compression in the nip.

While embodiments of the present invention have been described in the foregoing specification and drawings, it is to be understood that the present invention is defined by the following claims when read in light of the specification and drawings.

I claim:

1. An endless belt for a press section, the belt extending in machine and cross machine directions and having a vertical thickness, the belt comprising:
a first layer that is substantially impermeable to water and permeable to air;
a second layer that is impermeable to water and air and that includes a dimensionally stable substrate; and
between said first and second layers, a compressibly resilient body having a plurality of air pockets that are arranged to intake and exhaust air vertically through said first layer and that are arranged to essentially bar movement of air through said body in the machine and cross machine directions.

2. The belt of claim 1, wherein said dimensionally stable substrate comprises a yarn layer embedded in a substantially incompressible polymer.

3. The belt of claim 2, wherein said yarn layer is a woven fabric.

4. The belt of claim 1, wherein said first layer comprises perforated polyurethane.

5. The belt of claim 4, wherein said perforated polyurethane has plural slits, through which air permeates to and from said air pockets, said slits being substantially impermeable to water.

6. The belt of claim 1, wherein said first layer has a water repellant sheet-contacting surface.

7. The belt of claim 6, wherein said first layer is coated with a polytetraflouroethelene.

8. The belt of claim 1, wherein said compressibly resilient body comprises polyurethane particles forming walls that define vertical flow passageways.

9. The belt of claim 1, wherein said compressibly resilient body has a Shore A scale hardness of at least 70.

10. The belt of claim 1, wherein said compressibly resilient body comprises a multiplicity of spaced-apart vertical perforations that reach said first layer and said second layer, and wherein said first layer includes plural openings that communicate with respective ones of said perforations.

11. The belt of claim 10, wherein said openings are smaller than said perforations so as to be impermeable to water and permeable to air.

12. The belt of claim 1, wherein said first layer and said compressibly resilient body comprise a same polymer, wherein said first layer has openings that open to an exterior of the belt and that are substantially impermeable to water and permeable to air, and wherein said air pockets are internal to said compressibly resilient body and are larger than said openings and communicate vertically with respective ones of said openings.

13. The belt of claim 1, wherein said air pockets are charged with a chemical vapor other than air.

14. An endless belt for a press section, the belt extending in machine and cross machine directions and having a vertical thickness, the belt comprising:
a barrier layer adapted to engage a sheet passing through a nip of the press section, said barrier layer being substantially impermeable to water and permeable to air;
a roll-engaging layer that is opposite said barrier layer and that is adapted to engage a roller in the nip of the press section, said roll-engaging layer being impermeable to water and air and including a substantially incompressible belt-supporting substrate for providing dimensional stability to the belt; and
between said barrier and roll-engaging layers and immediately adjacent to said barrier layer, a void space layer that is resiliently compressible and that has a plurality of internal air pockets, said air pockets communicating vertically with said barrier layer to intake and exhaust air vertically through said barrier layer and not communicating in the machine and cross machine directions so that air in said air pockets moves vertically and not in the machine and cross machine directions when said void space layer is compressed and decompressed as the belt moves through a nip of the press section material.

15. The belt of claim 14, wherein said substrate comprises a reinforcing web.

16. The belt of claim 14, wherein said barrier comprises polyurethane that is perforated with plural slits, through which air permeates to and from said air pockets, said slits being substantially impermeable to water.

17. The belt of claim 14, wherein said barrier layer and said void space layer comprise a same polymer, wherein said barrier layer has openings that open to an exterior of the belt and that are substantially impermeable to water and permeable to air, and wherein said air pockets are larger than said openings and communicate vertically with respective ones of said openings.
